(19) United States
(12) Patent Application Publication
(10) Pub. No.: US 2012/0255207 A1
(43) Pub. Date: Oct. 11, 2012

(54) MULTI-PURPOSE HAND-HELD SPINNABLE SIGN

(76) Inventor: Stephan Waldt, Durham, NC (US)

(21) Appl. No.: 13/444,033

(22) Filed: Apr. 11, 2012

Related U.S. Application Data
(60) Provisional application No. 61/474,132, filed on Apr. 11, 2011.

(51) Int. Cl. G09F 7/00

(52) U.S. Cl. 40/427; 40/586

(57) ABSTRACT

Embodiments of a multi-purpose hand-held spinnable sign are disclosed. According to one aspect, a multipurpose, hand-held spinnable sign includes a sign body having a front surface and a rear surface, the front and rear surfaces adapted to display a message, text, image, or other indicia, and means, centrally positioned within front surface of the sign body, to allow a holder of the sign to spin the sign.

### PRIORITY CLAIM

This application claims the benefit of U.S. Provisional Patent Application Ser. No. 61/474,132, filed Apr. 11, 2011; the disclosure of which is incorporated herein by reference in its entirety.

### TECHNICAL FIELD

The subject matter described herein relates to hand-held signs. More particularly, the subject matter described herein relates to multipurpose hand-held spinnable signs.

### BACKGROUND

Attendees of sporting events, raffles, parades, or other public and private events often desire to show support for a particular person or political party, team or team participant, and so on, and may do so by displaying team colors, a team logo, the name or number of a favorite person or player, the number of a race car driver's car, etc. This support may be displayed on an article of clothing worn by the fan or on a banner or sign carried by the fan. Fans at an outdoor event may carry an additional device or article of clothing to provide protection against sun or rain. When fans of the same team gather in a group, they may desire to distract players of the opposing team in order to reduce the opposing teams performance and give advantage to the team favored by that group of fans. To do this, the fans may carry yet another device or article of clothing which is waved en masse by the fans in an attempt to break the concentration or otherwise distract an opponent during play. What is needed is a single device that can be carried by attendees of these events and that can be used for the functions of showing support for the person or team, providing protection from the elements for the fan, and/or providing distraction to the opponent. Accordingly, there exists a need for a multipurpose, hand-held, spinnable sign.

### SUMMARY

According to one aspect, the subject matter described herein includes a multipurpose, hand-held, spinnable sign comprising a support medium having a front surface and a rear surface, both adapted to display a message, text, image, or other indicia, the support media having hole therein, the hole centrally positioned to allow a holder of the sign to insert an object, such as a digit or rod, into the hole to become the axle around which the sign may be spun by the holder. In one embodiment, one surface of the sign may be used to display a logo, colors, numbers, names associated with a team, group, or party, or other indicia of support for the favored party while the other surface of the sign may be printed with a graphic design that, when spun, is intended to provide visual distraction to viewers of the sign. In this embodiment, the sign is used for the purpose of showing support to a favored party and also for the purpose of providing visual distraction to a disfavored party. In another embodiment, one surface of the sign may be used to display an indicia of support for the favored party while the other surface of the sign is used to display an indicia of opposition to the disfavored party. In one embodiment, the sign is composed of a material that provides to the holder of the sign some protection against sun or rain. In this embodiment, the sign is used for the purpose of showing support for a cause or party and also for the purpose of providing protection to the sign holder.

### BRIEF DESCRIPTION OF THE DRAWINGS

Preferred embodiments of the subject matter described herein will now be explained with reference to the accompanying drawings, wherein like reference numerals represent like parts, of which:

FIG. 1 illustrates a multipurpose, hand-held, spinnable sign according to an embodiment of the subject matter described herein;

FIGS. 2A and 2B illustrate obverse and reverse views of a multipurpose, hand-held, spinnable sign according to another embodiment of the subject matter described herein; and

FIG. 3 illustrates a cross-sectional view of a multipurpose, hand-held, spinnable sign according to yet another embodiment of the subject matter described herein.

### DETAILED DESCRIPTION

In accordance with the subject matter disclosed herein, a multi-purpose hand-held spinnable sign is herein described.

Reference will now be made in detail to exemplary embodiments of the present invention, examples of which are illustrated in the accompanying drawings. Wherever possible, the same reference numbers will be used throughout the drawings to refer to the same or like parts.

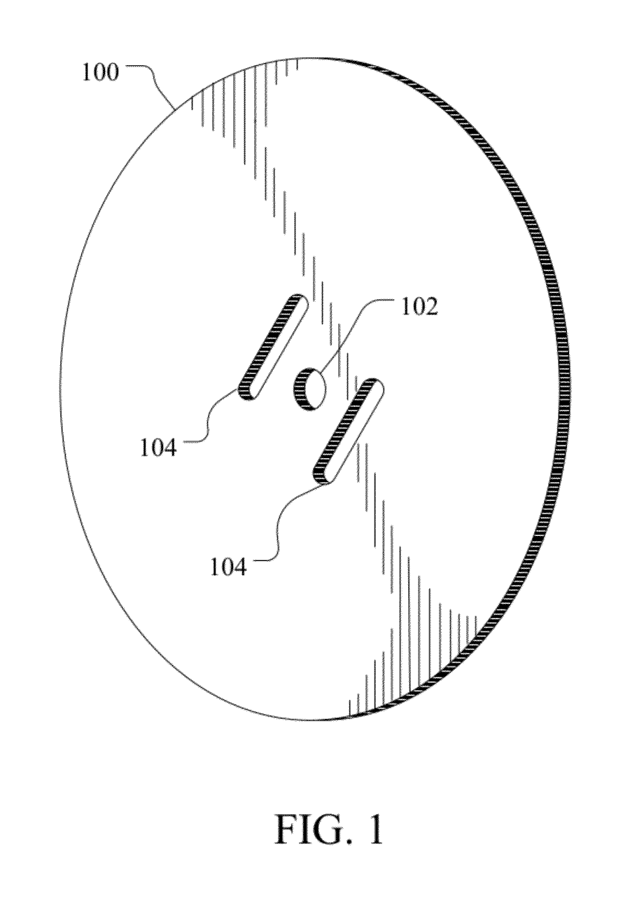

FIG. 1 illustrates a multipurpose, hand-held, spinnable sign according to an embodiment of the subject matter described herein. Multipurpose, hand-held, spinnable sign 100 comprises a sign body 102 having a front surface and a rear surface, the front and rear surfaces adapted to display a message, text, image, or other indicia, and means, centrally positioned within the front surface of the sign body, for allowing the sign to be rotated around an axis that is normal to the front and rear surfaces of the sign body by the holder of the sign. In the embodiment illustrated in FIG. 1, means for allowing the sign to be rotated around an axis that is normal to the front and rear surfaces of the sign body comprises a hole 104, through which a holder of the sign can insert an axle around which the sign may be spun by the holder. For example, the sign holder may spin sign 100 around his or her finger or thumb, a pencil or pen, etc.

In one embodiment, sign body 102 includes one or more additional holes 106 spaced in relationship to centrally positioned hole 104 such that a handle is formed by the support medium material that exists between centrally positioned hole 104 and additional hole or holes 106, or between additional holes 106.

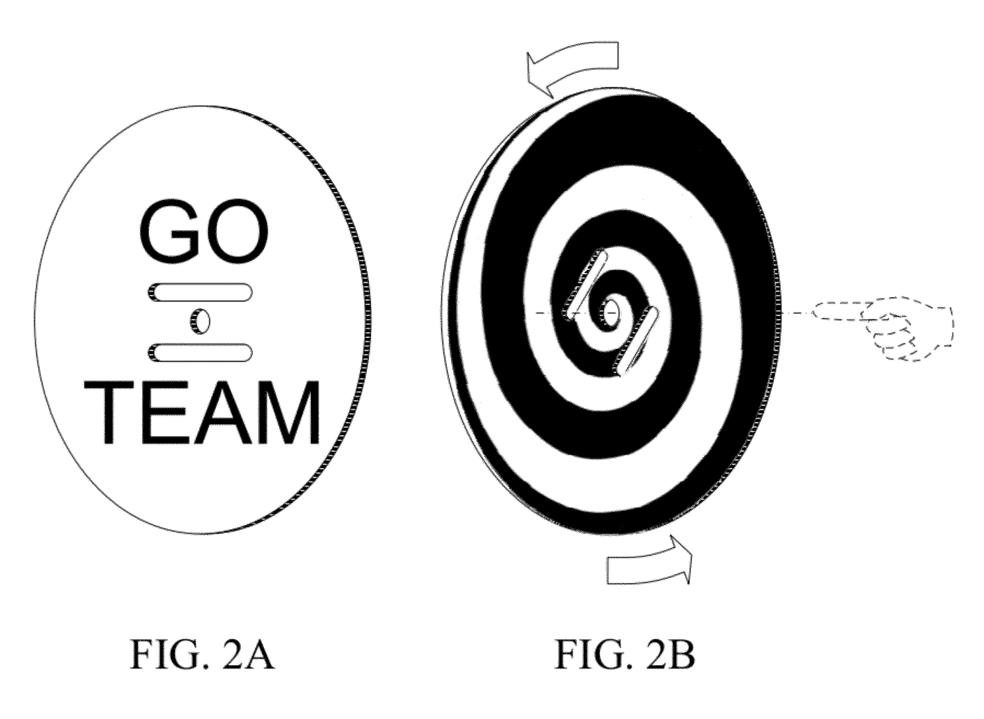

FIGS. 2A and 2B illustrate obverse and reverse views of a multipurpose, hand-held, spinnable sign according to another embodiment of the subject matter described herein. FIG. 2A illustrates an obverse view of sign 100, e.g., the front surface of the sign, showing a first graphic design, while FIG. 2B illustrates a reverse (rear) view of sign 100, e.g., the rear surface of the sign, showing a second graphic design.

In the embodiment illustrated in FIG. 2A, the front surface of the sign displays a message, text, image, or other indicia of support for a favored party, such as a team, a player, a political party, and so on, while the rear surface of the sign displays a graphic design which provides visual distraction when the sign is spun by the holder of the sign, as illustrated in FIG. 2B.

In one embodiment, sign 100 is made of a light-weight planar material such as corrugated cardboard, corrugated plastic, foam board, etc., with a hole in the middle of the display surface of the sign through which the sign holder can insert a finger, thumb, pencil, pen, or other object as an axle around which the sign may be spun, as shown in FIG. 2B. For example, a sign holder at a sporting event can display the front surface of the sign towards the field or court to show support for their favored team, but can turn the sign around to display the rear surface of the sign towards the field or court to visually distract players on the opposing team or to show opposition to the disfavored party.

In one embodiment, sign body 102 is made of a waterproof or water resistant material which the holder of the sign can use to shield himself or herself from exposure to weather, e.g., to protect the holder from falling rain or from exposure to sun.

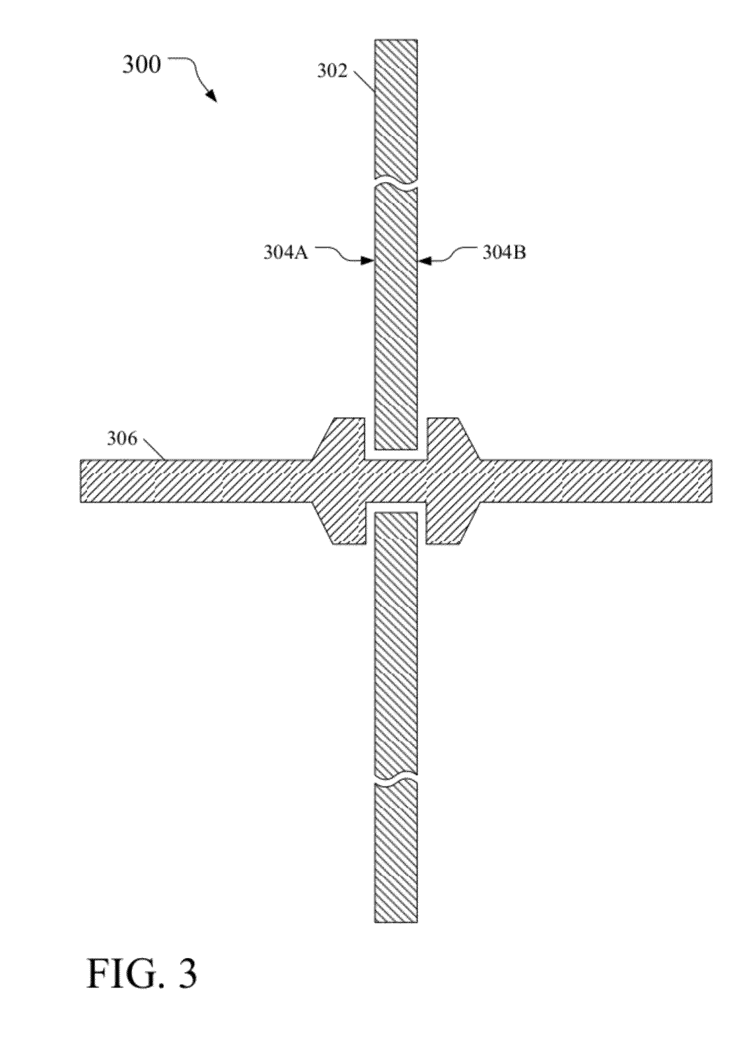

FIG. 3 illustrates a cross-sectional view of a multipurpose, hand-held, spinnable sign according to yet another embodiment of the subject matter described herein. In the embodiment illustrated in FIG. 3, sign 300 includes a sign body 302 having first and second display surfaces 304A and 304B, and also having an object, such as a handle 306, that is disposed along an axis normal to the display surfaces 304A and 304B of sign body 302 and which the holder of sign 300 may use to hold sign 300 while it is being spun by the holder. In one embodiment, handle 302 may be held stationary by the sign holder while sign body rotates around the handle. Alternatively, handle 306 may comprise a first portion that is held by the sign holder, a second portion that is fixed to sign body 302, and a bearing or other structural interface by which the first and second portions of handle 306 are mated such that the second portion rotates with sign body 302 while the first portion remains stationary relative to the sign holder.

It will be understood that various details of the subject matter described herein may be changed without departing from the scope of the subject matter described herein. Furthermore, the foregoing description is for the purpose of illustration only, and not for the purpose of limitation.

What is claimed is:

1. A multipurpose, hand-held spinnable sign comprising:
a sign body having a front surface and a rear surface, the front and rear surfaces adapted to display a message, text, image, or other indicia; and
means, centrally positioned within the front surface of the sign body, for allowing the sign to be rotated around an axis that is normal to the front and rear surfaces of the sign body by the holder of the sign.

2. The sign of claim 1 wherein means for allowing the sign to rotate around the axis that is normal to the front and rear surfaces of the sign body comprises an axle, normal to the front and rear surfaces of the sign body, around which the sign may be spun by the holder.

3. The sign of claim 1 wherein means for allowing the sign to rotate around the axis that is normal to the front and rear surfaces of the sign body comprises a hole suitable to accept an axle, normal to the front and rear surfaces of the sign body, provided by the holder of the sign, and around which the sign may be spun by the holder.

4. The sign of claim 3 wherein the sign body includes at least one additional hole spaced in relationship to the centrally positioned hole such that a handle is formed by the support medium material that exists between the two holes.

5. The sign of claim 1 wherein the sign body comprises corrugated cardboard, corrugated plastic, or foam board.

6. The sign of claim 1 wherein the front surface of the sign displays a first graphic design and wherein the front surface of the sign displays a second graphic design.

7. The sign of claim 1 wherein the front or rear surface of the sign comprises a design which provides a visual distraction when the sign is spun by the holder of the sign.

8. The sign of claim 1 wherein the front or rear surface of the sign comprises an indicia of support for a favored party.

9. The sign of claim 1 and the front or rear surface of the sign comprises an indicia of opposition to a disfavored party.

10. The sign of claim 1 wherein the sign body is comprised of a waterproof or water resistant material.
